(19) United States
(12) Patent Application Publication
(10) Pub. No.: US 2013/0321219 A1
(43) Pub. Date: Dec. 5, 2013

(54) ANTENNA IN ELECTRONIC DEVICE WITH SEPARABLE RADIATOR

(71) Applicant: Samsung Electronics Co., Ltd., Gyeonggi-do (KR)

(72) Inventors: Youngjun CHO, Seoul (KR); Byungman LIM, Seoul (KR); Donghwan KIM, Gyeonggi-do (KR); Sukho KIM, Gyeonggi-do (KR); Jaeho LEE, Gyeonggi-do (KR)

(21) Appl. No.: 13/905,710

(22) Filed: May 30, 2013

(30) Foreign Application Priority Data
May 31, 2012 (KR) 10-2012-0058319

(51) Int. Cl. H01Q 1/24

(52) U.S. Cl. CPC H01Q 1/243
USPC 343/702; 29/600

(57) ABSTRACT

A built-in antenna of a hand-held electronic device has separable radiators. The antenna includes a first radiator mounted to a first housing portion of the electronic device, and a second radiator mounted to a second housing portion. The first radiator and second radiator are electrically connected to each other when the first and second housing portions are assembled.

### CLAIM OF PRIORITY

This application claims the benefit under 35 U.S.C. §119(a) of a Korean patent application filed on May 31, 2012 in the Korean Intellectual Property Office and assigned Serial No. 10-2012-0058319, the entire disclosure of which is hereby incorporated by reference.

### BACKGROUND

1. Technical Field

The present disclosure relates to an antenna for use in an electronic device, and in particular, to a built-in antenna for use within portable hand-held communication devices

2. Description of the Related Art

In recent years, hand held mobile communication devices (i.e., “wireless terminals”) such as smart phones and tablet computers have been configured with a built-in type antenna rather than an extractable antenna, for purposes of aesthetics and durability. Today's mobile devices are commonly used at multiple frequency bands and communications protocols to achieve both traditional voice communications as well as data communications. The latter may involve downloading digital contents, video and audio files, and transmitting user data to another user (i.e., texting). For these tasks, different antenna radiators may be included for operations at different respective communication bands or protocols.

FIG. 1 illustrates a related art design of a wireless terminal configured for using a second generation (2G) or third generation (3G) communication protocol, in which an antenna radiator 1 is deployed in a lower end portion thereof. In this conventional design, a single antenna radiator 1 is used for both voice and data communication. The radiator 1 extends across the majority of the wireless terminal in the width direction, and is coupled to a feed point (not shown) on a printed circuit board (PCB) 12. Further, when a user holds the wireless terminal, any performance degradation caused by the user's hand is not too large to prevent suitable use.

However, as demand for data communication including a large amount of data is on the rise, it becomes difficult to provide an appropriate service with only one antenna for voice communication commonly used with an antenna for a data communication. Accordingly, a separate antenna dedicated for data communication is required. Further, as a communication method develops from 3G to 4G (Long Term Evolution: LTE), a separate 4G communication antenna, or a multi-band antenna used for both LTE and 3G frequencies, is added to a wireless terminal. Thus, at least two separate antennas are employed which occupy more space than for past designs.

In addition, due to space constraints, the one or more additional antennas are typically more complex, with more folds and bends to achieve a needed electrical length and impedance for operation at desired frequencies. These new designs may be more sensitive to the presence of a user's hand, whereby the radiation performance is often degraded unacceptably. An example of a related art wireless terminal employing such multiple antennas for voice, 3G and 4G is shown in FIG. 2. Two or more conventional antenna radiators 50, 60 are mounted in a lower end portion of a wireless terminal on opposite sides as seen in partial view (a). These antenna radiators are mainly covered by a user's hand during hand-held use of wireless terminal as seen in illustration (b). The two or more antenna radiators 50 and 60 are mounted in a lower end portion of a wireless terminal rear cover 10. Note that one or both of these radiators may be designed as multi-band radiators. In partial view (a), the rear cover 10 is facing up and a front cover 11 is facing down. Two or more antennas are required depending on a function or usage, for instance, an antenna for voice communication, an antenna for data communication, an antenna for 3G communication, and/or an antenna for 4G communication. In illustration (b), an area 300 partially encompassing antenna radiator 50, is mainly covered by the user's hand in a typical right hand grip position holding the wireless terminal. This area 300, which is adjacent a thick region of the user's palm below the thumb, is an area in which an antenna radiation performance is particularly deteriorated, due to blockage by the user's palm.

FIG. 3 shows a different perspective view of the related art wireless terminal and antenna radiators of FIG. 2. It is seen in view (a) that a portion 51 of the radiator 50 extends substantially to the lateral side edge of the wireless terminal. For instance, considering a typical mounting recess 18 for a screw, etc. in a corner of a generally solid rectangular wireless terminal (“bar shaped terminal”) as a reference point, the portion 51 of radiator 50 is disposed near the lateral side edge, and extends beyond the mounting recess 18.

As seen in view (b), the radiator end portion 310 of radiator 50 has been found to sensitively react even to a small influence of the outside. For instance, as a user holds the wireless terminal in the position shown in FIG. 2, performance is degraded at signal frequencies for which the radiator region 310 is designed.

### SUMMARY

The present disclosure provides an antenna having separable radiators, the separable radiators being mounted on wireless terminal housing portions (e.g., rear cover, front cover) for effective use of the limited space of the wireless terminal, where the separately mounted radiators become connected as the housing portions are brought together for assembly.

The present disclosure also provides an antenna having separable radiators whose antenna performance is improved by reducing an area of an antenna radiator covered by a user's hand when the user grips the wireless terminal.

In accordance with an aspect of the present disclosure, a separable antenna of an electronic device includes a first radiator mounted to a first housing portion of the electronic device, and a second radiator mounted to a second housing portion. The first radiator and second radiator are electrically connected to each other when the first and second housing portions are assembled.

In another aspect, a method of assembling a hand-held electronic communication device having a housing is provided. The method involves mounting a first radiator to a first housing portion of the housing; mounting a second radiator to a second housing portion of the housing; and assembling the first housing portion to the second housing portion so that the first radiator electrically contacts the second radiator to form an integrated built-in antenna.

### BRIEF DESCRIPTION OF THE DRAWINGS

Aspects, features and advantages of the presently disclosed technology will be more apparent from the following detailed description in conjunction with the accompanying drawings, in which:

FIG. 1 is a perspective view illustrating a conventional antenna radiator mounted in a lower end portion of a wireless terminal;

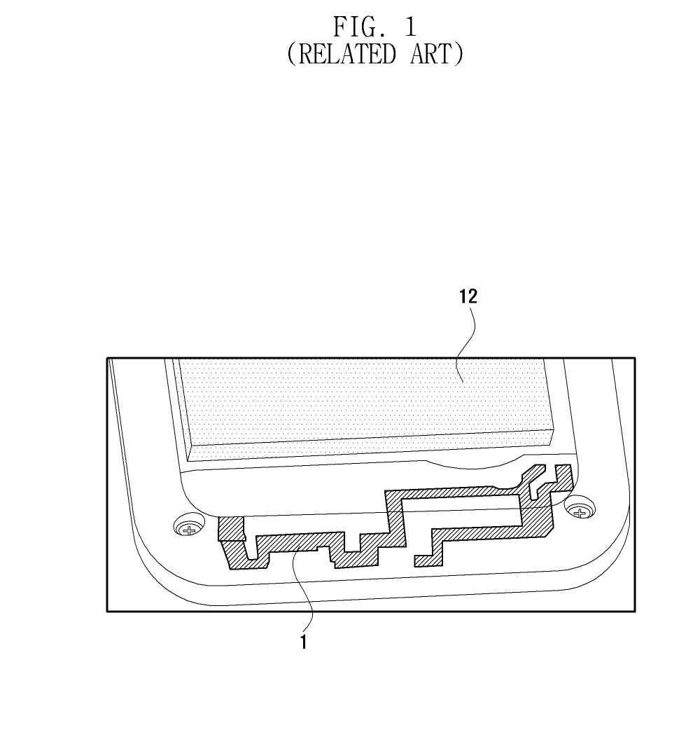

FIG. 2 shows perspective views illustrating a related art wireless terminal in which two or more conventional antenna radiators are mounted in a lower end portion thereof, and a portion of the wireless terminal where the antenna radiators receives a large influence when a user holds the wireless terminal;

FIG. 3 shows different perspective views illustrating the related art wireless terminal and antenna radiators 50, 60 of FIG. 2, and an enlarged view of the radiator 50;

FIG. 4 shows views illustrating an antenna radiator with two separated radiator portions in accordance with an exemplary embodiment, where the two radiator portions are mounted to different wireless terminal housing portions (e.g., a rear cover, a front cover);

FIG. 5 illustrates one way in which the two separated radiators of the embodiment of FIG. 4 become connected when the wireless terminal is assembled;

FIG. 6 is a perspective view illustrating a contact of two separated radiators when a wireless terminal is assembled;

FIG. 7 illustrates that two radiators are mounted separately in a front cover and a rear cover of a wireless terminal before assembling the front cover and the rear cover; and

FIG. 8 shows graphs illustrating antenna performance of an antenna according to an exemplary embodiment of the present disclosure, in comparison to performance of a related art antenna.

### DETAILED DESCRIPTION

Hereinafter, exemplary embodiments of the present invention are described in detail with reference to the accompanying drawings. The same reference numbers are used throughout the drawings to refer to the same or like parts. The views in the drawings are schematic views only, and are not intended to be to scale or correctly proportioned. Detailed descriptions of well-known functions and structures incorporated herein may be omitted to avoid obscuring the subject matter of the present invention.

As used in this document, including the claims section, the words “a” or “an” mean one or more than one. The term “plurality” means two or more than two. The term “another” is defined as a second or more. The words “comprising,” “including,” “having” and the like are open ended. Reference herein to “one embodiment,” “embodiments,” “an embodiment,” “first embodiment” or similar term means that a particular feature, structure, or characteristic described in connection with the embodiment is included in at least one embodiment. The appearances of such phrases in various places throughout this disclosure are not necessarily all referring to the same embodiment. Furthermore, the particular features, structures, or characteristics may be combined in any suitable manner on one or more embodiments without limitation. The terms “may” or “can” are used herein to refer to at least an optional element, feature, function, characteristic, advantage, etc., of a described embodiment. Terms such as “substantially” and “generally” mean that the recited characteristic need not be achieved exactly, but that deviations or variations may occur in amounts that do not preclude the effect the characteristic was intended to provide.

Herein, the terms “antenna”, “antenna radiator” and “radiator pattern” are synonymous and may refer to an element performing the same function, depending on the context of use. The terms “radiator” and “radiator portion” are used interchangeably to refer to radiating parts of an antenna.

Hereafter, an embodiment of an antenna having separable radiators will be described for an application of a hand-held wireless terminal, which is an example of an electronic device. Examples of a hand-held wireless terminal include a smart phone, a tablet computer, a smart camera, and so forth. However, it is understood that the present technology may be useful in other electronic devices requiring an antenna, where such other devices may be portable or fixed devices.

An antenna having separable radiators according to an exemplary embodiment of the present disclosure can be used to transmit/receive RF signals over multiple frequency bands and/or communication protocols (e.g., CDMA, PCS, LTE, etc.). The separated radiators can be mounted on any place of a wireless terminal housing (e.g., a housing comprising a rear cover and a front cover). In the following exemplary embodiment, separated radiators are mounted to a rear cover and a front cover, respectively, of the wireless terminal. However, other mounting configurations are possible in the alternative. A shape of the antenna radiator used in the present exemplary embodiment is an example and the present invention is not limited thereto.

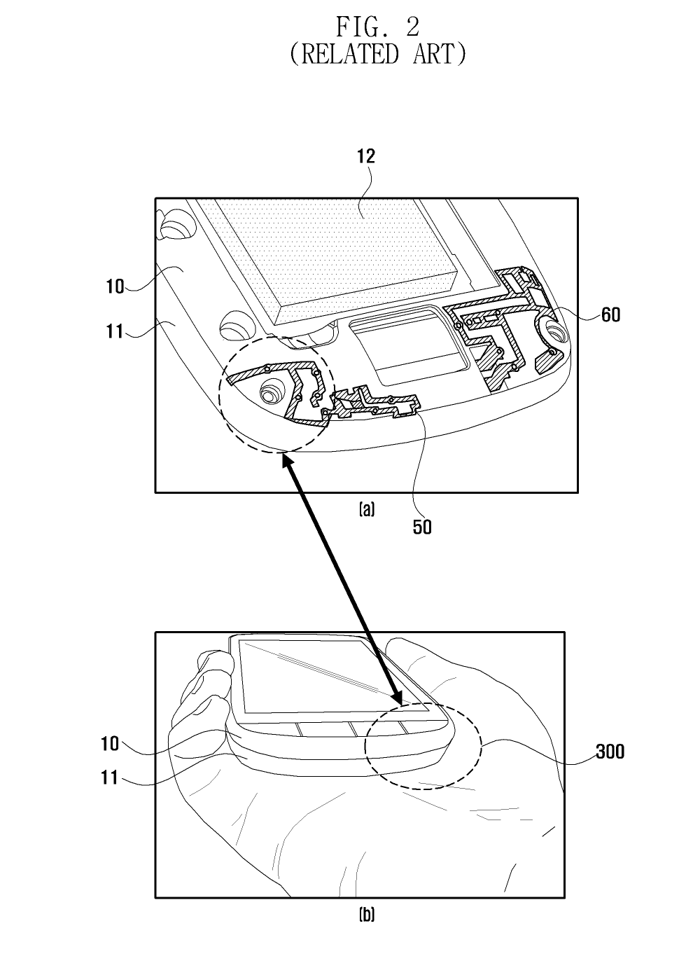

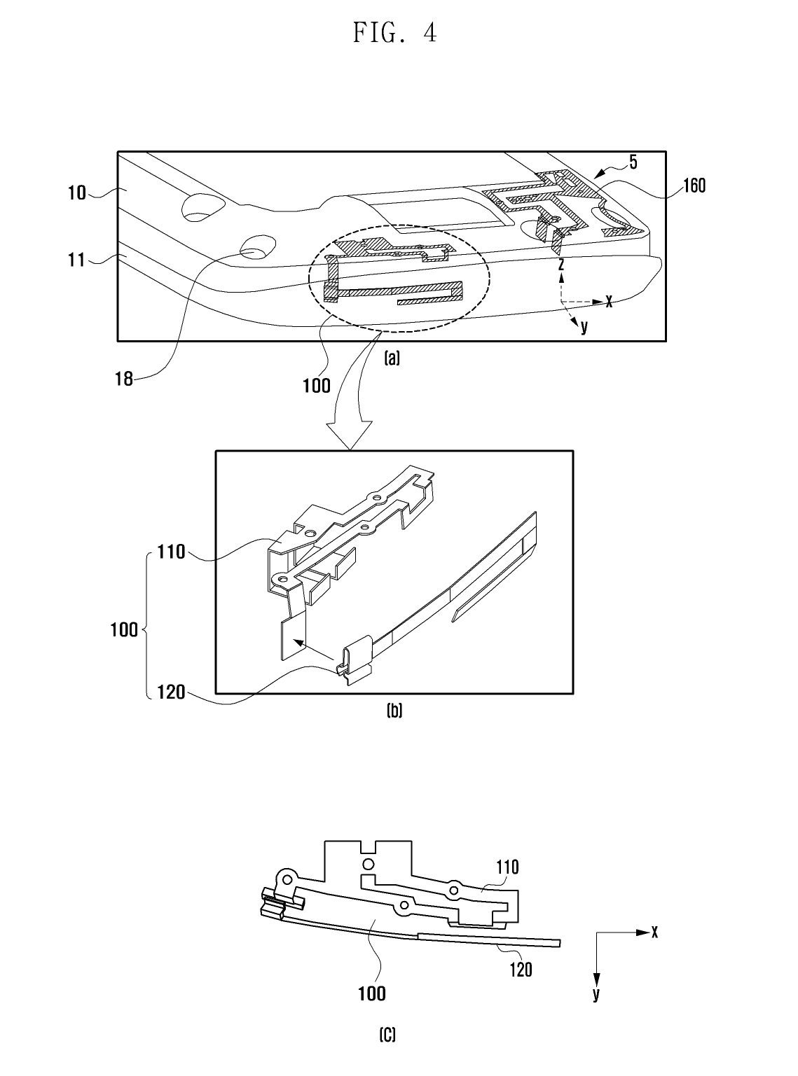

FIG. 4 shows views illustrating an antenna radiator 100 with two separated radiator portions 110 and 120 in accordance with an exemplary embodiment of the present technology. View (a) is a partial perspective view of a wireless terminal 5 comprising the first antenna 100 as well as a second antenna 160, where the latter may be the same or similar to the antenna 60 of FIG. 2. The two radiator portions 110, 120 of antenna 100 are each mounted to a different wireless terminal housing portion, e.g., the rear cover 10 and the front cover 11. In the example, radiator portion 110 (interchangeably, “first radiator” 110) is mounted to the inner side of the rear cover 10, and the radiator portion 120 (interchangeably, “second radiator” 120) is mounted to the inner side of the front cover 11. The two separated radiators 110, 120 make electrical contact with each other to perform a function of an integrated antenna 100 when the wireless terminal housing portions are assembled. An assembling position of rear cover 10 and front cover 11 can vary depending on types of a wireless terminal (e.g., a folder type, a bar type). Antenna 100 is RF coupled at a suitable point thereof to a feed point of a PCB of wireless terminal 5 (e.g., PCB 12 in related art wireless terminal discussed above, not shown in FIG. 4). The RF coupling point can be selected according to the radiator configurations, the frequency of operation, matching (VSWR) requirements, and so forth (e.g., whether the antenna 100 is designed as a multi-band antenna or single band antenna, etc.).

Prior to assembly of the front cover 11 to the rear cover 10 to form an integrated housing, the first and second radiators 110, 120 are mounted to the respective rear and front covers 10, 11. Only the first antenna radiator 100 may be separated into two or more radiators, and the second antenna radiator 160 may be used without such a separation. Alternatively, both the first antenna radiator 100 and the second antenna radiator 160 may be separated into two or more radiators. In addition, the present disclosure is not limited to a wireless terminal having two or more antenna radiators. In a wireless terminal having only one antenna radiator, it will become apparent to a person of ordinary skill in the art that the one antenna radiator can be separated into two or more radiators.

As shown in FIG. 4, illustrations (a) and (b), the second radiator 120 can be mounted on a vertically oriented surface of the front cover 11, with wireless terminal placed with its rear cover 10 on a horizontal surface. That is, as seen in view (a), the wireless terminal 5 can be in the general shape of solid rectangle (with or without curved edges), with a width dimension in direction “x”, a length dimension in direction “y” and a thickness dimension in direction “z”, where the width and length are each much larger than the thickness. Each radiator portion 110, 120 can be generally elongated in the x direction. Each radiator portion can have multiple sections that are each in the shapes of conductive strips. The front cover 11 is shown to have “lip” portion oriented in substantially the x-z plane, and the second radiator 120 can be mounted to, or patterned on, the inner surface of this lip portion. A majority of the external surface of the second radiator 120 can lie substantially in the x-z plane, while the majority of external surface of the first radiator 110 can lie in the x-y plane, as seen the views (a), (b) and (c) of FIG. 4. In an alternative implementation, the second radiator 120 can be mounted or patterned to the major surface of the front cover, i.e., a surface lying in the x-y plane of FIG. 4. In any event, as the front cover 11 and the rear cover 10 are brought together and assembled, the first radiator 110 and the second radiator 120 become connected to perform a function as one antenna radiator as shown in views (b) and (c) of FIG. 4.

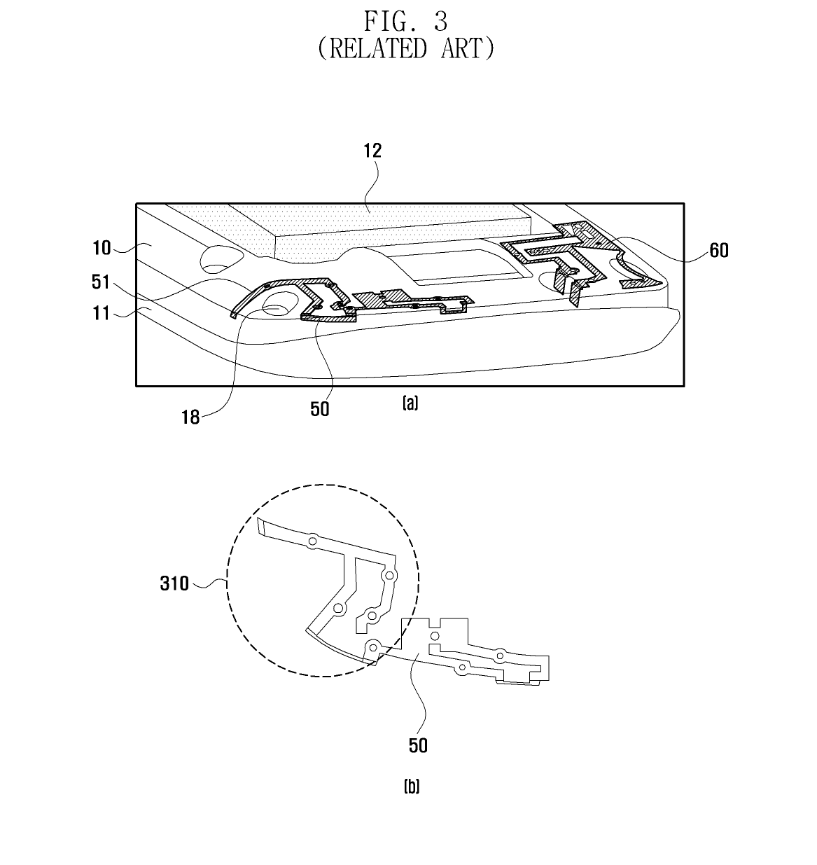

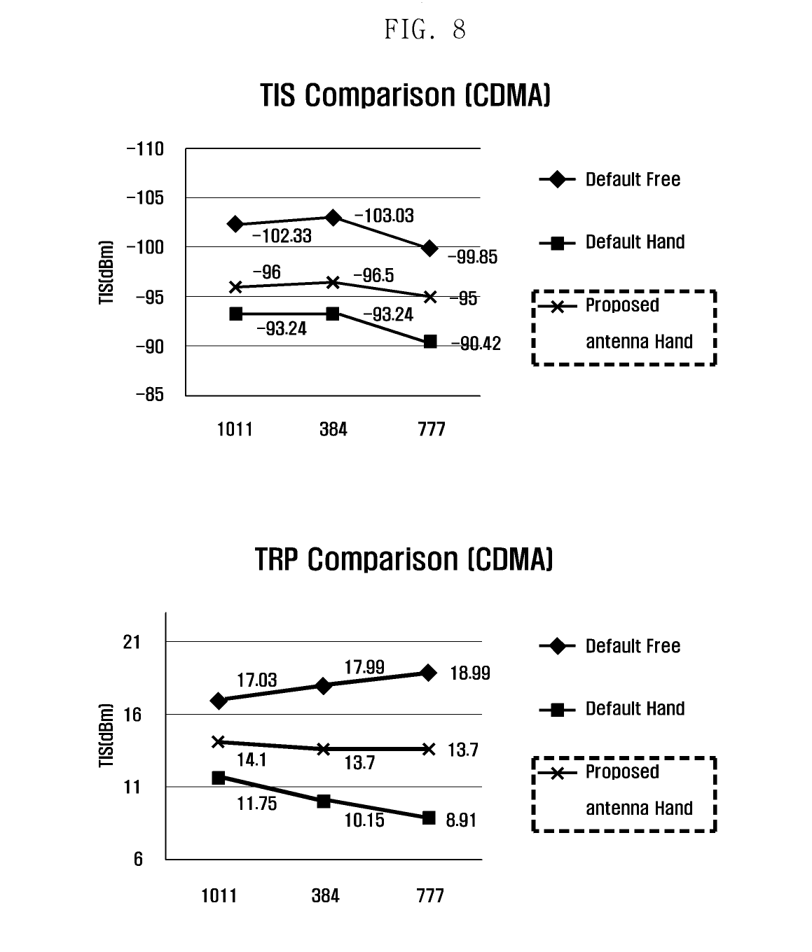

As shown in FIG. 4, view (a), the antenna 100 can be spaced away from the lateral side edge of the wireless terminal 5 in the x direction. For instance, antenna 100 may be disposed further away from the left edge than the mounting recess 18, from the perspective of view (a) in which the terminal 5 rests upside down on a horizontal surface (front cover 11 resting on a horizontal surface). In this case, one difference is readily apparent when comparing the configuration of the exemplary wireless terminal 5 to that of the related art wireless terminal of FIGS. 2 and 3. That is, in the related art wireless terminal, the antenna 50 extends substantially to the lateral edge of the wireless terminal in the width direction, contributing to the performance degradation due to proximity to a thick portion of the user's hand. In contrast, with the configuration of wireless terminal 5 of FIG. 4, the antenna is disposed away from the lateral edge, whereby degradation caused by the user's hand is less. A second notable difference is that the second radiator 120 is disposed substantially away from the major inner surface of the rear cover 10 in the z direction, and is therefore further away from the user's hand during use. These configuration changes are made possible by designing antenna 100 with separable radiators, where the first and second radiators are mounted to different housing portions. A combination of these two configuration changes can be used to improve antenna performance, as exemplified in the graphs of FIG. 8 described below.

Further, due to enhanced versatility afforded by separable radiators, the overall antenna design may be changed. Note that in the example of FIG. 4, the overall configuration of the integrated antenna 100 differs significantly from that shown in FIGS. 2 and 3. By way of example, radiators 110 and 120 are each elongated in the x direction with comparable total lengths in the x direction (for example, they may have total lengths extending in the x direction that are substantially the same, as shown in FIG. 4). Second radiator 120 has a first end that makes electrical contact with a first end of the first radiator 110. A second end of the second radiator 120 has a U shape. A second end of the first radiator 110 also has a U shape. An extent (length) of the U shape of the first radiator in the x direction can be longer than the extent (length) of the U shape of the second radiator in the x direction. For instance, the U shape of the second radiator 120 can have a length of about one half of the overall x direction length of the second radiator, while the U shape of the first radiator 110 can have a length of about three quarters or seven eights of its total length in the x direction.

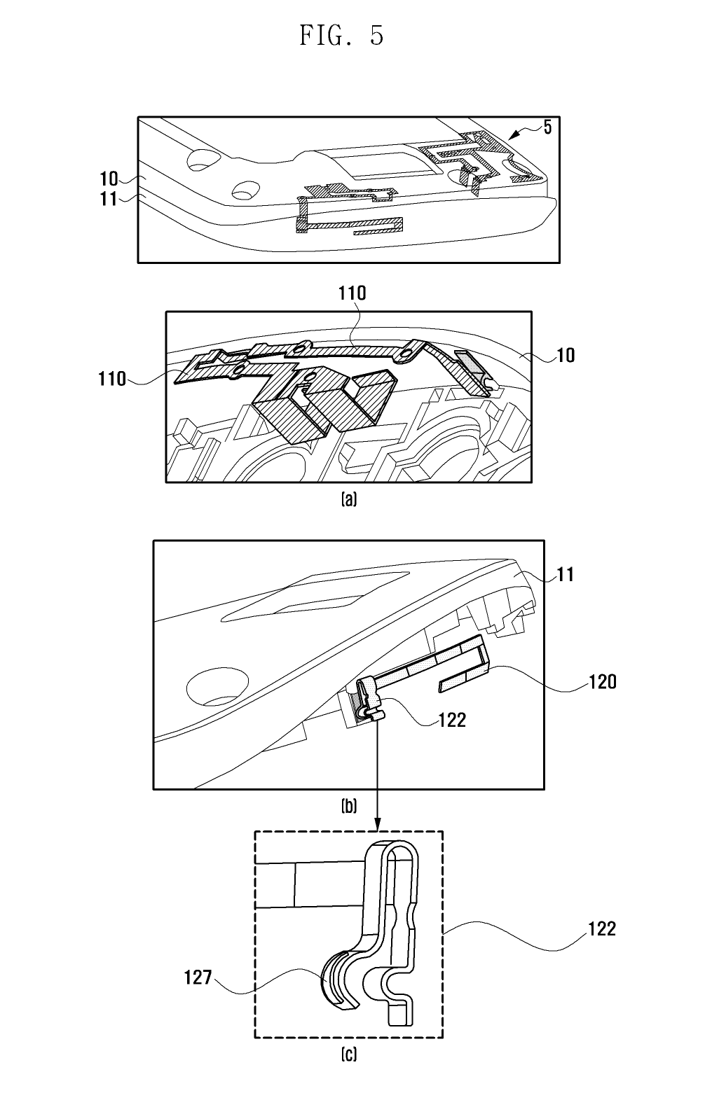

Further specifics of the example configuration are shown in FIGS. 5, 6 and 7. This configuration is merely exemplary and may optimize a design targeted for a particular band or bands of operational frequencies. Many other configurations are available for the radiators 110 and 120.

FIG. 5 illustrates one way in which the two separated radiators of the exemplary embodiment of FIG. 4 are become electrically connected when the wireless terminal 5 is assembled. Views (a) and (b) illustrate a separated structure of the first radiator 110 and the second radiator 120 in various angles.

The first radiator 110 and the second radiator 120 make contact through a radiator contact portion 122 as shown in view (c). For example, the radiator contact portion 122 can be a contact portion of a C-Clip shape having an elastic force. Other types of flexible contact members may be utilized in alternative implementations. The first radiator 110 and the second radiator 120 can be designed to make contact in various aspects.

Further, when the wireless terminal 5 is disassembled for repair, the first radiator 110 and the second radiator 120 can be easily disconnected. When the separated housing portions are reassembled, the two radiators 110, 120 are reconnected.

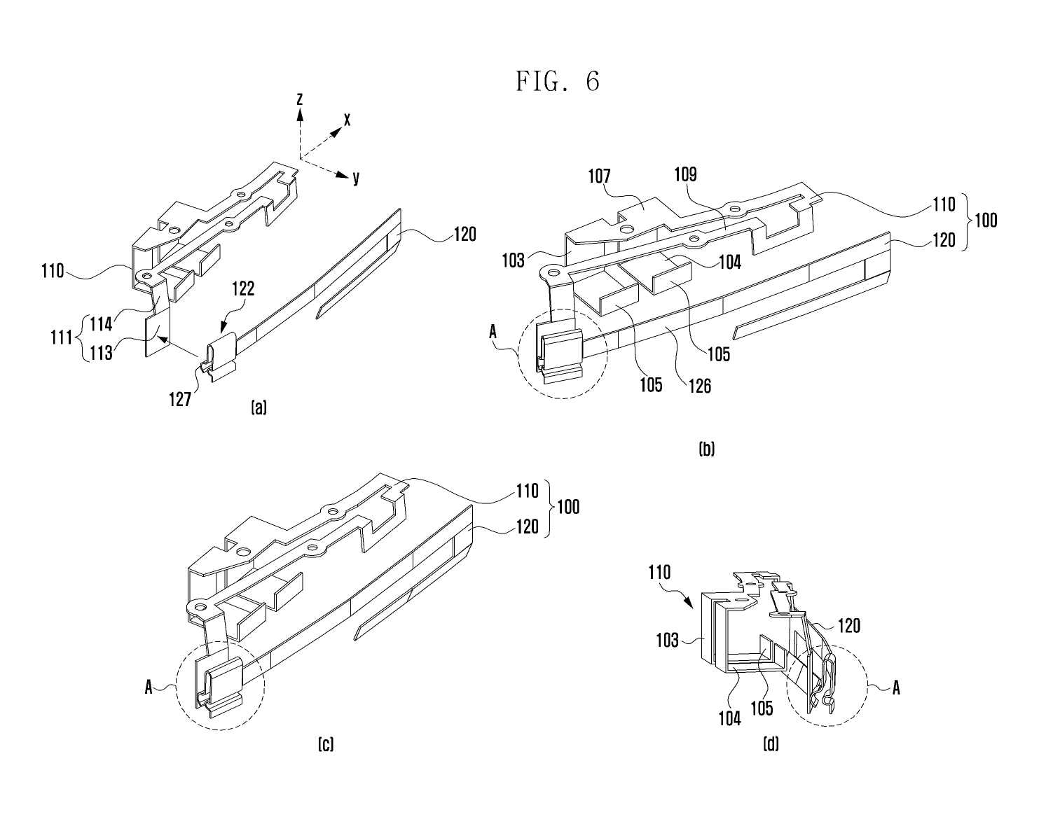

FIG. 6 depicts detailed perspective views from various angles illustrating a contact of two separated radiators when a wireless terminal is assembled. View (d) illustrates a side view of a contact portion of a C-Clip described in relation of FIG. 5. Because the C-Clip has a strong elastic force, the contact portion of the radiator 120 can be effectively contacted to the radiator 110. Once the first radiator 110 and the second radiator 120 are connected, the first radiator 110 and the second radiator 120 are not easily disconnected as a result of the C-Clip's elastic force. Further, the shapes of the first radiator 110 and the second radiator 120 are examples. The present disclosure is not limited to the example shapes.

In the particular example illustrated, the C-Clip is an integrated portion of the second radiator; however, a C-clip or alternative connection member can be alternatively provided as a separate component. A region “A” denotes a general contact region between the first and second radiators 110, 120. The first radiator 110 has a radiator contact portion 111 comprising an extension tab 114 and a contact tab 113 connected to an end of the extension tab 114. The radiator contact portion 122 has a contact surface 127 that contacts the contact tab 113 when the front and rear covers of wireless terminal 5 are brought together. The contact tab 113 may lie in substantially the x-z plane. A major surface 126 of second radiator 120 may also lie substantially in the x-z plane. First radiator 110 can have major surfaces 109 and 107 elongated in the x direction and lying substantially in the x-y plane. As mentioned above, radiator 110 can have a U-shape extending about three quarters or seven eighths the overall length in the x direction. In addition, radiator 110 can have a second U shape region that is oriented generally in the y-z plane. As seen in views (b) and (d), for example, this second U shape region can comprise a first section 103 oriented in the x-z plane, which connects to a second section 104 extending in the x-y plane, which in turn connects to a third section 105 (“upward lip” shape) oriented in the x-z plane. Further, two separated portions of the second U shape region can be provided as shown.

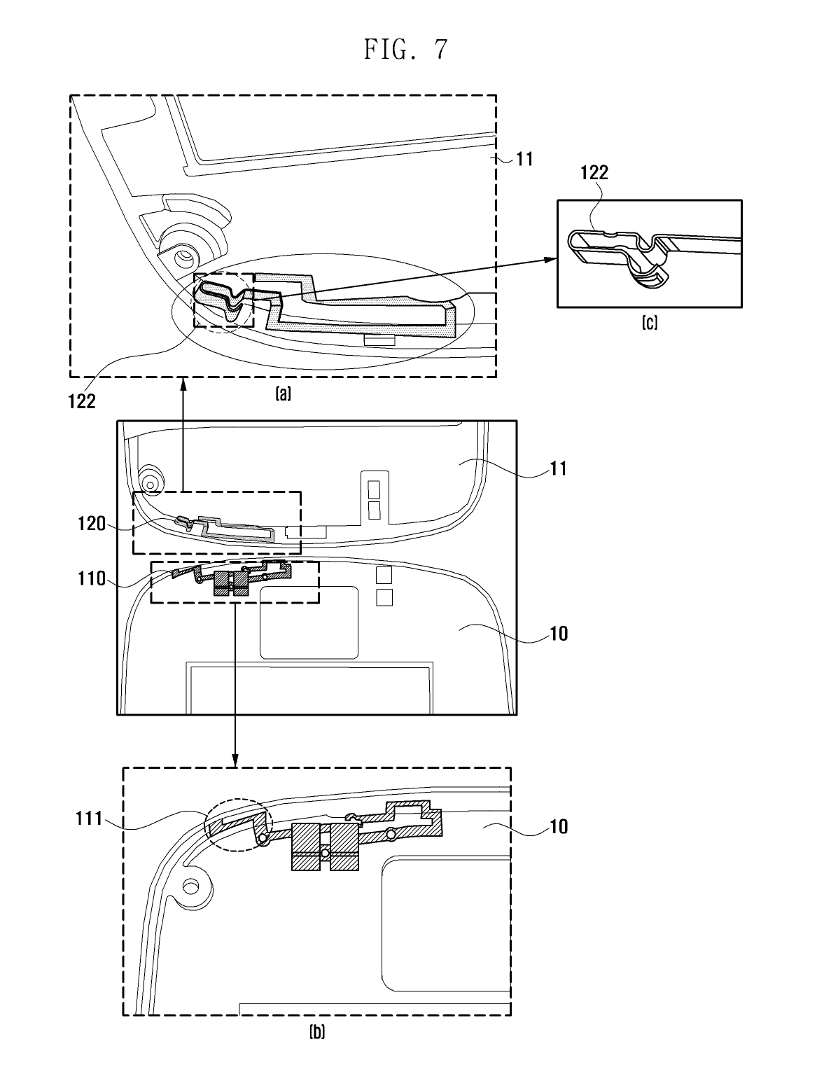

FIG. 7 illustrates two separated radiators of a built-in antenna for a wireless terminal mounted in a front cover and a rear cover respectively before assembling the front cover and the rear cover of the wireless terminal 5. Partial views (a), (b) and (c) are illustrated. When the front cover 11 to which the second radiator 120 is mounted and the rear cover 10 to which the first radiator 110 is mounted are assembled, the radiator contact portion 122 of the second radiator 120 shown in view (a) and a first radiator contact portion 111 of the first radiator shown in view (c) are connected to realize an integrated antenna 100 comprising the first and second radiators 110, 120. Further, the first radiator 110 and the second radiator 120 may be mounted in an antenna structure of fusion-bonding or an in-mold antenna type. The first and/or second radiators 110, 120 may be formed as conductive strip patterns bonded to the inner surfaces of the rear and front covers, respectively. In alternative configurations, the second radiator 120 is mounted to the rear cover 10 and the first radiator 110 is mounted to the front cover 11.

FIG. 8 shows graphs illustrating antenna performance of an exemplary antenna according to an exemplary embodiment of the present disclosure, in comparison to performance of a related art antenna. The top graph illustrates a Total Isotropic Sensitivity (TIS) vs. frequency, and the bottom graph illustrates a Total Radiated Power (TRP) vs. frequency. As is apparent from FIG. 8, the TIS and the TRP show the degree of performance changes according to an exemplary embodiment of the present disclosure. In these graphs, “default free” represents a measured value in a situation where the wireless terminal is not held by a user's hand (i.e., a state where an antenna radiator is not covered by a user's hand), “default hand” represents a measured value in a situation where a user holds the wireless terminal, and “proposed antenna hand” represents a measured value after a user holds a wireless terminal having separable radiators described in an exemplary embodiment of the present disclosure. As the graphs illustrate, when an antenna having separable radiators is used, both the TIS and the TRP of the proposed antenna hand are improved in comparison with the default hand. It is readily seen that an antenna performance is improved when the proposed antenna hand is used in accordance with the exemplary embodiment of the present invention.

As described above, according to the presently disclosed technology, by mounting an antenna having separable radiators in a wireless terminal, multiple radiators can be mounted in areas where conventional radiators cannot be mounted. This affords increased versatility in antenna designs, whereby superior antenna configurations are achievable. Further, when a user grips the wireless terminal, an area where the antenna radiator is covered by the user's hand is reduced. Thus, an adverse influence by the user's hand is minimized and an antenna performance is improved.

Although exemplary embodiments of the present disclosure have been described in detail hereinabove, it should be clearly understood that many variations and modifications of the disclosed embodiments are apparent to persons of skill in the art, and all such variations and modifications are within the scope of the invention as defined by the appended claims.

What is claimed is:

1. A separable antenna in an electronic device, the antenna comprising:
a first radiator mounted to a first housing portion of the electronic device; and
a second radiator mounted to a second housing portion of the electronic device,
wherein the first radiator and the second radiator are electrically connected when the first and second housing portions are assembled together.

2. The antenna of claim 1, wherein at least one of the first radiator and the second radiator is mounted to a surface of the first or second housing having one dimension oriented in a thickness direction of the electronic device.

3. The antenna of claim 1, wherein at least one of the first radiator and the second radiator has a contact portion of a C-Clip, the C-Clip having an elastic force and using a conductive connection member.

4. The antenna of claim 1, wherein the first radiator and the second radiator are automatically separated when the wireless terminal is disassembled, and the first radiator and the second radiator are reconnected when the wireless terminal is re-assembled.

5. The antenna of claim 1, wherein a shape of the first radiator or the second radiator is a function of an internal structure of the first housing or the second housing.

6. The antenna of claim 1, wherein the first housing portion is a rear cover of the electronic device and the second housing portion is a front cover of the electronic.

7. The antenna of claim 1, wherein the first radiator or the second radiator is mounted in the first housing portion or the second housing in a fusion-bonding or in-mold form.

8. The antenna of claim 1, wherein the electronic device is a bar shaped wireless terminal.

9. The antenna of claim 1, wherein the electronic device is generally solid rectangular and has a width, length and thickness, and the first and second radiators are each mounted in a lower end of the electronic device.

10. The antenna of claim 9, wherein each of the first and second radiators is elongated in the width direction, and each has at least one U-shaped portion.

11. The antenna of claim 10, wherein each of the first and second radiators is substantially spaced from a lateral side edge of the electronic device in the width direction.

12. The antenna of claim 11, wherein the first and second radiators are each strip conductors, and a major surface of the first radiator is oriented orthogonal to a major surface of the second radiator.

13. A method of assembling a hand-held electronic communication device having a housing, comprising:
mounting a first radiator to a first housing portion of the housing;
mounting a second radiator to a second housing portion of the housing; and
assembling the first housing portion to the second housing portion so that the first radiator electrically contacts the second radiator to form an integrated built-in antenna.

14. The method of claim 13, wherein the first housing portion is a rear cover and the second housing portion is an opposing

15. The method of claim 13, wherein mounting the first radiator to a first housing portion comprises a fusion-bonding or in-mold process.

16. The method of claim 13, wherein one of the first and second radiators comprises a flexible member integrated therewith to electrically contact a surface of the other of the first and second radiators during the assembling of the first housing portion to the second housing portion.
